(19) United States
(12) Patent Application Publication
(10) Pub. No.: US 2025/0008304 A1
(43) Pub. Date: Jan. 2, 2025

(54) BANDWIDTH OPTIMIZATION THROUGH AGGREGATED MULTI-CASTING OF MEDIA STREAMS

(71) Applicant: Sling TV L.L.C., Englewood, CO (US)

(72) Inventors: Robert Drew Major, Orem, UT (US); Mark Hurst, Cedar Hills, UT (US); Kyle Powell, American Fork, UT (US)

(73) Assignee: Sling TV L.L.C., Englewood, CO (US)

(21) Appl. No.: 18/757,306

(22) Filed: Jun. 27, 2024

Related U.S. Application Data
(60) Provisional application No. 63/511,131, filed on Jun. 29, 2023.

(51) Int. Cl. H04W 4/06

(52) U.S. Cl. CPC H04W 4/06

(57) ABSTRACT

Systems, devices, and automated processes optimize bandwidth utilization in wireless network systems such as satellite systems, 5G and other cellular networks, and wireless local area networks with multiple distribution nodes. Redundant unicasts of media streams are replaced by multicasts that can be transmitted by a subset of the available distribution nodes. This allows customer devices to receive redundant content over shared bandwidth that is available to the particular customer devices requiring access to the redundant content. Subsets of distribution nodes can be selected for transmitting multi-casts, thereby further reducing the amount of system bandwidth needed to provide high-quality media streams to multiple customer devices operating within the wireless network system.

### PRIORITY CLAIM

This application claims priority to U.S. Provisional Application Ser. No. 63/511,131 filed on Jun. 29, 2023, which is incorporated herein by reference.

### TECHNICAL FIELD

The following generally relates to wireless data networks, such as satellite networks, 5G mobile networks and wireless local area networks (WLANs). More particularly, the following relates to systems, devices and automated processes to reduce bandwidth utilization of shared network links.

### BACKGROUND

Wireless networks that transport digital data are becoming increasingly deployed for personal and commercial use. Satellite networks, for example, are becoming more sophisticated, more capable and more widely used for personal and commercial purposes. At the same time, fifth generation (“5G”) broadband cellular networks are being widely deployed around the world. These 5G networks use emerging technologies to support data and voice communications with millions, if not billions, of mobile phones, computers and other devices. Even further, wireless local area networks (WLANs) such as Wi-Fi networks are becoming more commonplace in the home and other settings. Each of these new wireless technologies is capable of supplying substantial amounts of bandwidth even as customers become increasingly mobile, thereby supporting an ever-increasing number of new applications and uses.

Even as network access improves, challenges nevertheless remain in allocating limited bandwidth amongst the many different customers and customer applications. Media streaming, for example, can quickly consume substantial amounts of bandwidth on any network. Various attempts have been made to mitigate the customer experience in limited bandwidth situations. Modern adaptive streaming techniques, for example, can make very efficient use of bandwidth available to a particular customer for a unicast stream. If multiple unicasts are being simultaneously provided over a common data channel (e.g., a shared satellite link, WLAN or 5G network slice), however, even very efficient unicasts can quickly overwhelm the shared bandwidth. This could ultimately lead to undesirable interruptions or delays. At the very least, when the shared bandwidth becomes constrained, adaptive unicast systems could undesirably degrade the quality of each unicast stream, thereby making the customer experience less optimal.

Substantial technical challenges therefore arise in managing the limited bandwidth within a satellite, cellular or WLAN networking system. A desire therefore exists to build systems, devices and automated processes that allow for intelligent routing of media programs and other bandwidth-intensive digital content within a wireless network that includes multiple distribution nodes. These and other features are described in increasing detail below.

### BRIEF SUMMARY

According to various embodiments, bandwidth in a satellite, cellular, WLAN or other wireless communications system can be used more efficiently by replacing parallel unicast media streams with a single multicast stream that can be simultaneously received by all of the customer devices operating within broadcast range of a common distribution node. Popular media programs, for example, can be multicast on shared bandwidth representing a channel that is known to multiple customer devices. Rather than each customer device obtaining its own unicast of the same media program via its own bandwidth, the shared bandwidth of the common distribution node can simultaneously distribute the shared program to each of the devices that are interested in receiving the program.

The concepts described herein may be used in any wireless networking systems in which multiple transmission points are available to customer devices. Examples of such networking systems could include, without limitation, satellite internet systems, WLAN implementations having multiple routers or wireless access points, 5G or other cellular networks, and/or other networks as appropriate. In each of these settings, customer devices can “tune” to receive multi-cast channels available from one or more of the available distribution nodes, thereby further improving the efficiency of the system.

In one example embodiment, an automated process is performed by a distribution management system of a wireless networking system that supports communications with a plurality of customer devices via a plurality of distribution nodes. The automated process suitably comprises: identifying a plurality of shared media programs that are received by more than one of the customer devices; dedicating, for each of a plurality of shared media programs, a multi-cast channel on at least one of the distribution nodes to a multi-cast of the shared media program; obtaining, by the distribution management system for each of the plurality of shared media programs, segments of the shared media program for re-transmission on the multi-cast channel associated with the shared media program; and distributing, to each of the customer devices via the wireless networking system, a manifest describing the shared media programs and identifying the multi-cast channel and distribution node that is dedicated to the multi-cast of the media program to thereby permit each of the customer devices to obtain the segments of the shared media program from the multi-cast of the media program.

Other embodiments relate to a network distribution management system for a wireless networking system. The distribution management system suitably comprises a processor, a non-transitory data storage and an interface to support communications with a plurality of customer devices via a plurality of distribution nodes, wherein the non-transitory data storage comprises computer-executable instructions that, when executed by the processor, perform an automated process.

These and other example embodiments are described in increasing detail below.

### DRAWING FIGURES

FIG. 1 shows an example of a wireless network system that supports multi-casting of media streams amongst multiple distribution nodes and customer devices.

FIG. 2 is a data flow diagram illustrating example processes and interactions between a media source, a distribution system and customer devices in a wireless network system.

FIG. 3 is a flowchart illustrating an example of a process performed by a subscriber device in a wireless network system.

FIG. 4 is a flowchart illustrating an example of a process performed by a distribution controller in a wireless networking system.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, bandwidth within a satellite, cellular, WLAN or other network system is conserved by replacing unicast media streams sent to multiple customer devices with a shared multicast that can be simultaneously received by each of the customer devices operating within the broadcast range of the multicast. Bandwidth can be further optimized by multicasting via only one (or a few) of the multiple distribution nodes operating within range of the various customer devices requesting the multicast. Customer devices within the broadcast range of the selected distribution node are able to tune in to the multicast and receive the desired media stream from shared bandwidth, thereby reducing the need for a separate unicast that could otherwise consume substantial amounts of bandwidth within the distribution system. US Patent Publication 2023/0128962, incorporated herein by reference, describes several systems and processes to efficiently allocate shared bandwidth on a wireless link, although other embodiments may use other systems and techniques as appropriate.

The multicasts supplied within the wireless network system can be dynamically updated in real-time (or near real-time, considering some delays inherent in data processing and transmission) as conditions change. Different media programs, for example, may be added or removed from a multicast as demand for the programs changes over time. Similarly, different satellites, access points or other distribution nodes can be tasked with transmitting the appropriate multicasts, with nodes updated over time based upon changes in demand, node position and/or other conditions as warranted.

Shared programs can be recognized in any number of different ways. Some embodiments could recognize the shared programs by monitoring and comparing requests for media programs as the requests transit the distribution system. In other embodiments, customer and/or distribution nodes could share state tables or other information that advertises channels where program segments can be located. Timing issues in the shared stream can be addressed through caching by the distribution system and/or the customer device, and additional error correction can be added to the multi-cast if desired.

Bandwidth can be further optimized by selecting only a subset of the distribution nodes to transmit the multi-cast. If a satellite ground station simultaneously communicates with several different overhead satellites, for example, different channels associated with multicasts of different programs can be efficiently assigned across the available satellites to avoid duplication, thereby further improving the allocation of bandwidth in the system. Similarly, terrestrial networks that place nodes in simultaneous contact with multiple routers, gateways or other access points can allocate multicast channels across the different data links to reduce duplication of data transmissions in the overall system.

The general concepts set forth herein could be implemented across any number of different network environments. In some implementations, a satellite internet system that uses a cluster of satellites orbiting the earth could identify parallel (or near-parallel, e.g., accepting some differences in time) unicasts of media streams or the like, and replace those parallel streams with a single multi-cast transmitted on a satellite that is within range of the various customer devices interested in receiving the multicast program. As satellites move out of range of the customer devices initially receiving the multicast, other satellites coming into range can be tasked with continuing delivery of the multicast so that the stream is not interrupted. One example of a satellite network system that uses a large cluster of satellites in polar orbit is the STARLINK satellite network operated by the SPACEX Corporation of Hawthorne, California. Other examples of satellite networks include the HUGHES JUPITER, HX, HT and HUGHESNET services operated by Hughes Network Systems of Germantown, Maryland. Any number of equivalent embodiments could be implemented using other satellite network systems as desired.

In other implementations, a wireless local area network (WLAN) system has multiple routers, gateways or other access points each providing network access to various customer nodes. Multicasts can be initiated on certain access points to reduce the number of parallel unicast streams that would otherwise by handled by the system. Access points may use, for example, any of the various IEEE 802.11 (“Wi-Fi”) standards promulgated and updated from time to time, or any other network protocols or standards as desired. Multi-point WLAN networks could be implemented across a home, office, campus, stadium, hotel, apartment complex, airport, train or bus station, and/or other environment as desired. Still other embodiments could be implemented within a 5G or other cellular network having multiple cellular access points, as appropriate. Again, any number of alternate but equivalent embodiments could be formulated using any terrestrial, cellular, satellite or other wireless networks, as desired.

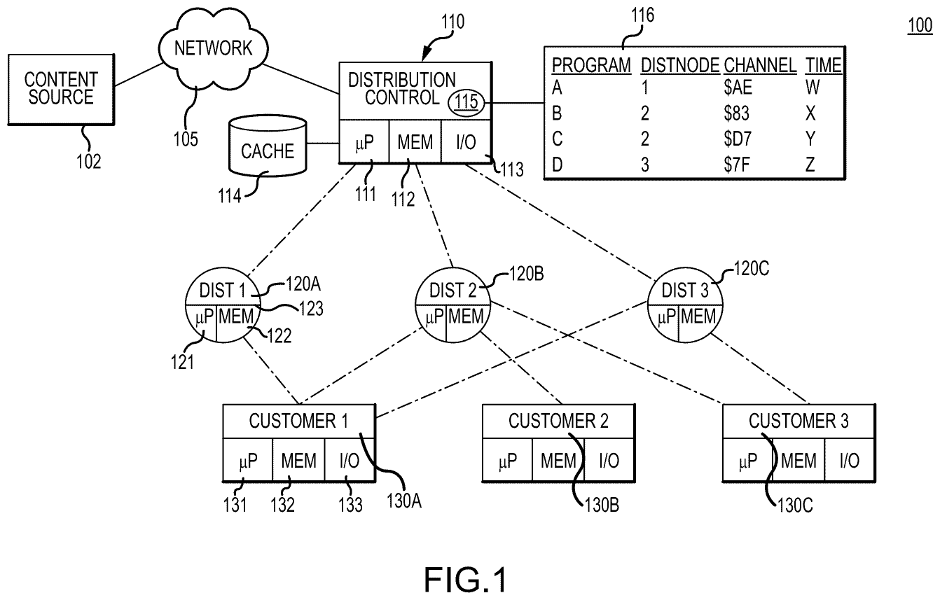

FIG. 1 illustrates one example of a network distribution system 100 that includes any number of distribution nodes 120A-C that communicate with any number of dispersed customer devices 130A-C. Distribution of data can be controlled by a distribution control system 110, as described more fully below.

In operation, each of the customer devices 130A-C use distribution system 100 to obtain data, messages and other communications via services 102 on the Internet or another network 105. Various services could include email, voice or text messaging, web browsing, media streaming and/or any other services as desired. Customer devices 130A-C may obtain streams of media programs from a media streaming service 102, for example, using conventional media streaming techniques and protocols. Other embodiments could equivalently process other types of data, including messaging, static or dynamic web content, file transfers, and/or the like.

As noted above, system 100 may be configured to replace parallel unicast streams delivered to different customer devices 130A-C with a multicast that can be simultaneously received by multiple customer devices 130A-C that are viewing the same media stream. In FIG. 1, for example, customer devices 130A and 130B are both in communication with distribution node 120B. If both devices 130A and 130B are viewing simultaneous media streams of the same program, the simultaneous multicasts could be replaced with a shared multicast provided by distribution node 120B. Rather than each node obtaining its own unicast of a popular stream, then, customer devices 130A-C could simply opt to receive the multicast, thereby reducing bandwidth consumption within system 100.

Customer nodes 130A-C are made aware of available multicasts in any manner. In one example, a distribution control system 110 executes an automated process 115 that directs different distribution nodes 120A-C to allocate channels to certain multicasts as appropriate. A manifest or other table 116 may be created and maintained to track the various multicasts provided by nodes 120A-C. Manifest 116 can be shared with the various customer devices 130A-C on any regular or irregular time basis to permit each of the devices 130A-C to locate and receive multicasts of desired programs. Other embodiments allow customer devices 130A-C and/or distribution nodes 120A-C to share tables of data indicating the locations of available media segments and/or multi-casts. These and other techniques are described in increasing detail below.

In some implementations, system 100 is a satellite communications system that uses geosynchronous, polar-orbiting or other satellites as distribution nodes 120A-C to communicate with various customer devices 130A-C that may be spread over a wide (or narrow) geographic area. The various satellites acting as distribution nodes 120A-C may have overlapping service areas that change frequently with satellite orbit, thereby necessitating dynamic change in the multicast channels allocated to the various satellites. In this example, distribution control system 110 may be provided in a terrestrial (or space-based) data processing system that includes one or more processors 111, as well as magnetic, optical and/or solid state non-transitory data storage 112 and appropriate input/output interfaces 113 as desired. The distribution control functions 115 could equivalently be distributed across space-based processing (e.g., on one or more satellite nodes 120A-C) and/or implemented using cloud-based processing resources, if desired.

In other implementations, system 100 relates to a terrestrial distribution network such as a 5G or other cellular network, a WLAN implementation, and/or the like. Distribution nodes 120A-C could therefore represent wireless gateways, routers or other access points that communicate with phones, tablets, personal computers and/or other devices 130A-C operating in the WLAN environment. In still other equivalent embodiments, nodes 120A-C represent cellular access points providing wireless communications to mobile phones or other cellular enabled devices 130A-C as desired. Distribution nodes 120A-C may therefore be implemented with any sort of router, gateway, access point or the like having conventional hardware such as a processor 121, memory or other non-transitory data storage 122 and input/output interfaces 123 as desired. In each of these different settings, multi-cast channels can be allocated on one or more distribution nodes 120A-C to provide transmissions of media streams or other content for simultaneous reception by multiple customer devices 130A-C as desired.

Again, distribution control functions 115 could be provided by a distribution control system 110 executing on conventional computing hardware (including cloud-based hardware). Control functions 115 could equivalently be distributed across one or more distribution nodes 120A-C, if desired. Generally speaking, control system 110 will identify popular media streams that are candidates for multicast distribution, will coordinate data acquisition of media segments or the like from content source 102, and will direct one or more distribution nodes 120A-C to allocate a multi-cast channel for distributing the segments of the media stream. Multi-cast channel information may be kept in a manifest, digest or other table 116 that is shared with the customer devices 130A-C to assist in locating the various multicasts that may be available. Generally speaking, manifest 116 will include an identifier of the program, as well as identifiers of the nodes 130A-C and channels where the multicast is being transmitted. Various embodiments may also include timing information relating to the start time of the media stream, the current time of the media stream (e.g., by MPEG presentation time stamp (PTS) or the like), or any other reference as desired. Distribution control system 110 may also have access to additional non-transitory data storage 114 that can be used to temporarily cache media segments or other data prior to transmission, if desired. Equivalent embodiments could additionally or alternatively rely on caching at distribution nodes 120A-C and/or customer devices 130A-C, as appropriate.

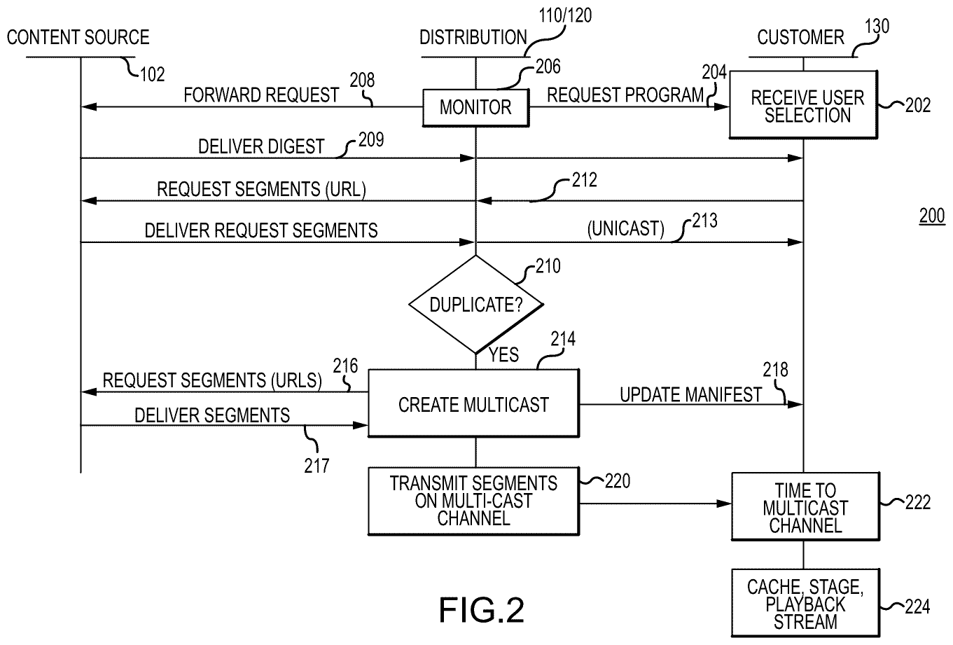

FIG. 2 illustrates examples of automated processes performed by content source 102, distribution system 110/120 and customer device 130 to distribute multicasts of shared media programs. The various processes will typically be carried out by computing hardware that is programmed with software or firmware instructions stored in non-transitory data storage of the appropriate device. Again, the various functions and routines illustrated in FIG. 2 could be modified or implemented in any other way.

FIG. 2 illustrates an example process 200 to distribute multicasts of shared media content across multiple distribution nodes 120A-C to multiple customer devices 130A-C. In the example of FIG. 2, a user of customer device 130 appropriately selects a media program for viewing in any manner (function 202). In various embodiments, the user may select the program using a program guide or other interface feature of a media player application, although other implementations may function in other ways. Customer device 130 transmits a request 204 for the selected program via communications system 100; the request may be addressed to the content source 102 on network 105 and/or to the distribution system 110/120 as desired.

In the example of FIG. 2, distribution system 110/120 suitably monitors requests 204 received from the various customer devices 130A-C for various programs. This monitoring could assist in identifying which programs are most popular within network 100, and/or which devices 130A-C would most benefit from a multicast. If multiple customer devices 130 are within range of a common distribution node 120, for example, then that node 120 would make an excellent candidate to host the multicast, as opposed to a different node 120 that currently services fewer customer devices 130 that are interested in the particular program.

In conventional adaptive media streaming, distribution system 110/120 forwards the program request 204 to the content source 102 via network 105 (function 228). The content source 204 may be a media service, content delivery network (CDN) and/or the like that provides segments of the requested program in response to client-generated requests, which are often formatted as conventional hypertext transport protocol (HTTP) requests. The content source 102 receives the request 228 and responsively forwards a digest 209 of the requested program that identifies uniform resource locators (URLs) or other addresses of the various segments making up the media stream. Digest 209 may also describe different bit rates or other quality parameters that may be available. Typically, the client device uses the address data in the digest 209 to identify and obtain segments of the media stream having an appropriate quality for the user's device while also maintaining playback without interruption due to network congestion, changes in bandwidth or other issues that may be encountered throughout the duration of the media stream. If the requested program is not available via a multicast (function 210), then the distribution system 110/120 suitably forwards the digest 209 to the customer device 130 to permit client-driven unicast streaming as appropriate. Customer device 130 therefore requests segments of the unicast stream directly from the content source 102 using the addresses contained in digest 209 (function 212), and responsively receives the requested segments (function 213) from the content source in a unicast session with the content source 102. US Patent Publication No. 2023/0128962 describes several techniques for adaptive media streaming that make use of client requests for different segments of the stream, although other embodiments could use other streaming techniques as desired.

Distribution system 110/120 may select programs for multicasting in any manner. In various embodiments, multicast programs are selected by an operator based upon expected popularity or other factors. In other embodiments, system 110/120 recognizes popular programs based upon the program requests 204 that are received from the various customer devices 130 and dynamically reacts by dedicating multicast channels on various nodes 120 for the more popular programs (function 214). In the example of FIG. 1, the distribution system 110/120 places appropriate segment requests 216 to content source 102 using information from digest 209 and responsively receives segments 217. Segments may be requested using URLs contained in digest 209 previously requested by one or more customer devices 130, if desired. Alternatively, distribution system 110/120 can independently request and receive its own digest for the program. Received segments 217 can be uploaded to the appropriate distribution node(s) 120 for re-transmission on the allocated multicast channel (function 220) as desired.

Quality of media segments requested by distribution system 110/120 could be configured in any manner. In various embodiments, the quality selected may be relatively high in comparison to the quality allowed for unicast streams, owing to the efficient usage of bandwidth within the broadcast/multicast structure. In some implementations, more than one multicast channel can be allocated on the same or different nodes 120 to accommodate different segment qualities. A mobile phone customer device 130 may use a different segment quality than a media player attached to a 5K digital television, for example. To that end, different multicast streams could be provided to accommodate different quality streams of the same program if enough demand for each different quality exists. Even if multiple multicasts of a stream are provided at different qualities, bandwidth is still conserved if each multicast prevents multiple unicasts of that stream at a particular quality that would otherwise be needed.

Multicast channels may be fashioned in any manner (function 214). In the example illustrated in FIG. 2, the distribution channels can be implemented using internet protocol (IP) multicasting based upon a dedicated address on a network interface of one or more distribution nodes 120. A media player application or the like executing on customer device 130 can therefore “tune” to the multicast (function 222) by attaching (e.g., with a socket structure of the like) to the appropriate multicast address and receiving the various packets that are transmitted by node 120 using that address.

Customer devices 130 receive, cache, stage/arrange and playback the various segments of the media stream in any manner (function 224). In various embodiments, segments received via unicast and multicast delivery mechanisms could be combined as appropriate, thereby providing even more flexibility. If a viewer is watching a program at a playback point that is delayed behind the multicast, for example, a media player on customer device 130 could be configured to immediately tune to the multicast and to store the received segments for future playback while simultaneously using unicast mechanisms to retrieve segments up to the point that cached segments are available. Even if different customers are watching the same program at different playback points, then, the multicast may still be useful if it reduces (but does not quite eliminate) the amount of unicast traffic sent to the customer device 130. Caching may be most effective if the cache is local to the playback device 130 since this will minimize data transmissions from distribution node 120. Caching at distribution control system 110 and/or distribution node(s) 120 may be used to supplement or replace local caching, if desired.

Unicasts may also be used to prevent playback interruptions if a multicast becomes unavailable for any reason (e.g., a satellite providing the multicast moves out of broadcast range). Unicasts may also supplement a multicast stream in the event that one or more segments of the multicast are corrupted, since the customer device 130 could simply obtain replacements for the corrupt segments while continuing to view or cache the multicast remainder of the stream. Even though some unicast streams may persist over network 100, the unicasts will be shorter lived, and will conserve bandwidth of the overall system over time.

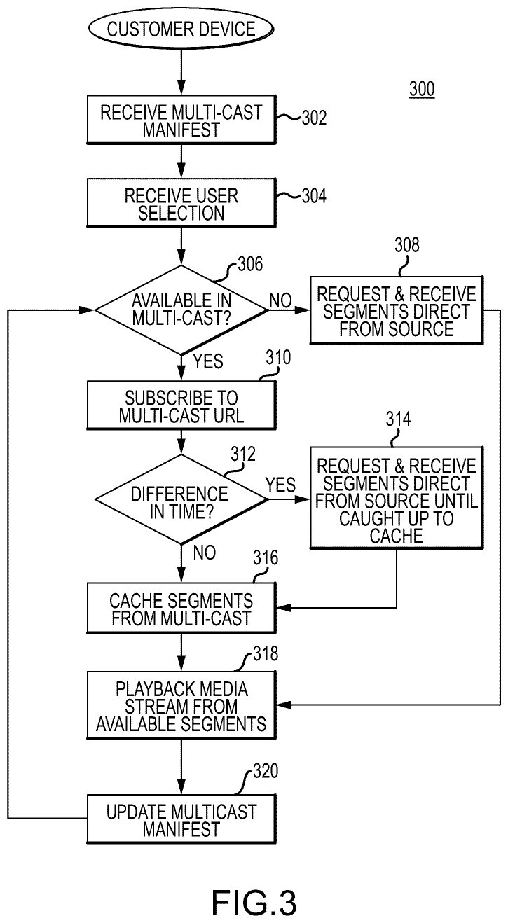

Customer devices 130 may be configured in any manner. In various embodiments, a media player application or the like executing on the customer device 130 can be programmed to perform various functions and actions as described herein. FIG. 3 is a flowchart illustrating an example automated process 300 performed by the various customer devices 130A-C operating within network distribution system 100. In the example of FIG. 3, customer devices 130A-C are able to combine unicast and multicast techniques to obtain a media stream of a desired program. The various functions and features shown in FIG. 3 may be combined with each other and/or supplemented in any manner to implement any number of alternate but equivalent embodiments.

As illustrated in FIG. 3, customer device 130A-C suitably receives manifest 116 of multicast programs in any manner (function 302). Manifests 116 may be broadcast systemwide on a regular or irregular temporal basis, if desired; equivalently, manifests 116 could be sent on an as-needed basis (e.g., whenever the manifest is updated with new information). Manifests 116 could be fashioned so that all customer nodes 130A-C in system 100 receive a complete manifest 116. In other embodiments, the manifest 116 is tailored to a geographic region, a type of customer device and/or in any other manner so that customer devices 130A-C receive a subset of the multicasts available in system 100, recognizing that many of the multicasts may not be of interest to all devices 130. Some multicasts may be transmitted by nodes 120 that are out of range of the customer device 130, for example, or some of the multicasts may provide quality levels that are not of interest to that particular device 130. Other factors (user demographics, type of device, system status, device status, etc.) could be considered as well in generating multicast manifests 116 for customer devices 130A-C operating within system 100.

As noted above, customer device 130 receives an input from a user that indicates a desired program to obtain and play back (function 304). In the example of FIG. 3, the customer device 130 determines whether the requested program is available as a multicast (function 306). If not, unicast streaming based upon client requests for segments described in digest 209 can commence (function 308). If the requested program is one of the programs described in the received manifest 116, however, then the multicast can be “tuned” (function 310) and segments can be received and cached as desired (function 316). If the currently transmitted segments of the multicast are for future portions of the program (function 312), then the customer device 130 can begin caching the segments of the multicast while simultaneously requesting and receiving unicast segments (function 314) directly from media source 102 until the playback point of the cached segments is reached. Again, caching the segments by the customer device 130 allows for variations of playback time between different customer devices 130 receiving the same multicast. For certain types of programs (e.g., live broadcasts of sports programming), the variations in playback time between different viewers may be particularly small, since many viewers will want to remain relatively close to the live broadcast. Other programs may have widely varying playback times, but if suitable cache storage is available, viewing time can be shifted from the live multicast as appropriate.

As noted above, manifests 116 may be updated in any manner (function 320). Manifests 116 may be received at regular time intervals, on an as-needed basis, or in any other manner. In some implementations, distribution system 110/120 could send an updated manifest if the monitoring function 206 (FIG. 2) recognizes a request 204/308 for a unicast stream that is already available to the customer device 130 as a multicast. Note that multicasts could be interrupted (e.g., by the discontinued availability of a node 120 supplying the multicast), and/or new multicasts could be added as distribution system 110/120 generates new multicasts. New multicasts may also become available as new satellite nodes 120 come into range, or as the customer device 130 moves to a new geographic location that is covered by a different access point node 120. The dynamic nature of the multicasts described by manifest 116 creates a system that is both efficient and flexible.

Distribution systems 110/120 may also be configured in any manner. In many embodiments, a centralized distribution management system 110 will handle most, if not all, of the multicast configuration and manifest generation functions. Some implementations, however, will distribute some or all of this functionality amongst one or more distribution nodes 120A-C as desired. Reference to “distribution systems 110/120” herein, then, is intended to recognize that distribution functions are not limited to ground based or other centralized processing systems 110 but may be augmented or replaced with processing on the distribution nodes 130A-C, as desired.

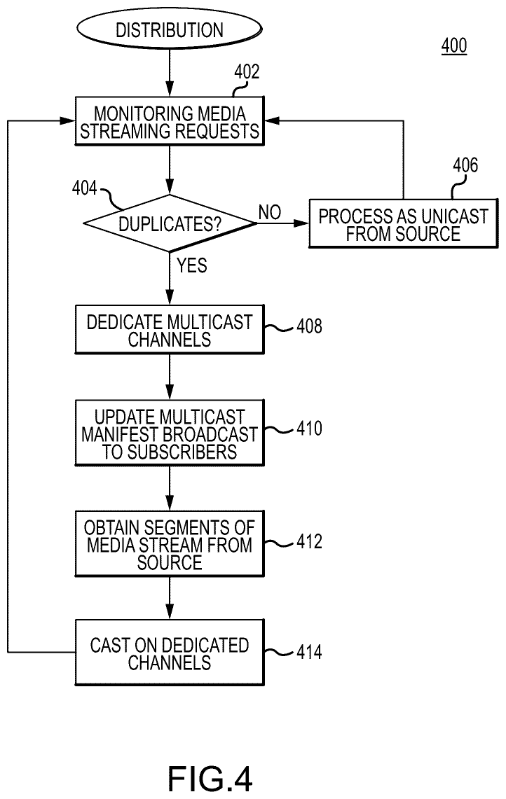

FIG. 4 is a flowchart illustrating one example of an automated process 400 performed by a distribution system 110/120 operating in a network system 100. In the example of FIG. 4, distribution system 110/120 suitably monitors media streaming requests passing through the system 100 to identify duplicate media streams (function 402). Duplicate streams (function 404) can be assigned to multicast channels (function 408), if desired, while non-duplicate streams can be handled as unicast streams (function 406). Duplicate streams can be automatically detected, as described above. In other embodiments, however, the particular programs selected for multicast are determined based upon historical data (e.g., which programs are known to be most popular), possibly as modified by demographic or geographic data, or other factors as appropriate. Automatic detection of duplicate streams may be a useful feature in many embodiments, but it is not necessary in all implementations.

As noted above, multicast streams can be described in one or more manifests 116 that are distributed to customer devices 130A-C on any temporal basis (function 408). Manifests 116 may be updated in real-time as new multicasts are added or removed, if desired, or manifests 116 may simply be distributed according to a pre-determined time schedule. Some embodiments could generate manifests 116 for each distribution node 120A-C that are broadcast to customer devices 130A-C, thereby permitting each customer device 130 to see the particular multicasts available from each of the distribution nodes 120A-C that are within range. Manifests 116 may be transmitted via an out-of-band or control channel provided by the distribution node 120, or in any other manner.

Media content that is transmitted on the multicast channels may be obtained in any manner (function 412). In the example of FIG. 2, the distribution system 110/120 requests media segments of a desired quality from the content source 102 using conventional media streaming protocols, as appropriate. These media segments can be reformatted for transmission on an address associated with the multicast (e.g., a multicast IP address on a network interface of one or more nodes 120) in any manner (function 414). In some implementations, multicasts are formatted as user datagram protocol (UDP) packets that contain media segment data. By attaching to the appropriate multicast address, customer device 130 can receive, cache, decode and provide the packets transmitted on that address for playback as desired.

Customer devices 130 may be directed away from unicast streams and toward one or more multicast streams in any manner. In some embodiments, customer devices 130 are configured to review updated manifest received from the distribution system 110/120 to check for any relevant multicasts so that the device 130A-C can request future segments on the multicast stream. In other embodiments, distribution system 110 and/or 120 can issue redirect instructions (e.g., hypertext transport protocol (HTTP) redirects) to relevant customer devices 130 so that the customer devices 130 are able to obtain future segments from the multicast stream without necessarily reviewing the manifest. Other embodiments may operate in any other manner desired.

The various techniques and concepts described herein may be modified or supplemented in any manner. Additional intelligence could be used, for example, to identify particular distribution nodes 120A-C that would be most efficient providers of certain multicasts based upon location, demographics of users connected to each node 120A-C, and/or other factors as desired. One example of a segment mesh distribution system is described in U.S. Pat. No. 11,539,768 (which is incorporated herein by reference), although other mesh techniques could be equivalently used, if desired. Still other embodiments could use enhancements to content source 102 that provide more optimal formatting or delivery of multicast content for delivery within system 100, if desired.

Various embodiments therefore provide systems, devices and processes to replace multiple parallel unicasts distributed to multiple customer devices with multi-casts of the shared content that are transmitted by certain distribution nodes available to each of the multiple customer devices. Consolidating shared media programing into multi-cast channels that are provided by selected distribution nodes can provide substantial bandwidth savings to the overall network, as well as to individual distribution nodes. The improved bandwidth utilization provided by the multicast may further provide better quality media streams in some situations, thereby further improving the customer experience. Other embodiments may provide additional benefits and features, as desired.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. An automated process performed by a distribution management system of a wireless networking system supporting communications with a plurality of customer devices via a plurality of distribution nodes, the automated process comprising:
identifying a plurality of shared media programs that are received by more than one of the customer devices;
dedicating, for each of a plurality of shared media programs, a multi-cast channel on at least one of the distribution nodes to a multi-cast of the shared media program;
obtaining, by the distribution management system for each of the plurality of shared media programs, segments of the shared media program for re-transmission on the multi-cast channel associated with the shared media program; and
distributing, to each of the customer devices via the wireless networking system, a manifest describing the shared media programs and identifying the multi-cast channel and distribution node that is dedicated to the multi-cast of the media program to thereby permit each of the customer devices to obtain the segments of the shared media program from the multi-cast of the media program.

2. The automated process of claim 1 wherein each multi-cast channel is represented by a multi-cast internet protocol (IP) address provided on a wireless interface of the distribution node that is dedicated to the multi-cast of the media program.

3. The automated process of claim 2 wherein the segments of the shared media program are transmitted by the wireless interface of the distribution node using the multi-cast IP address identified in the manifest.

4. The automated process of claim 1 wherein the identifying of the plurality of shared media programs comprises monitoring requests for media programs received from the customer devices and recognizing those media programs receiving multiple requests from different customer devices.

5. The automated process of claim 4 wherein the identifying further comprises recognizing that the customer devices placing the requests for the shared media programs are in communication with the same one of the plurality of distribution nodes.

6. The automated process of claim 5 wherein the at least one of the plurality of distribution nodes is the same one of the plurality of distribution nodes in communication with the customer devices placing the requests for the shared media devices.

7. The automated process of claim 6 wherein the dedicating comprises assigning a multicast internet protocol (IP) address on a downlink interface of the same one of the plurality of distribution nodes.

8. The automated process of claim 7 wherein the same one of the plurality of distribution nodes is one of several distribution nodes in simultaneous communication with the customer devices placing the requests for the shared media devices, and wherein the multi-cast channel is provided on the same one of the plurality of distribution nodes but not on the other nodes of the several distribution nodes.

9. The automated process of claim 1 wherein each of the plurality of distribution nodes is a satellite, and wherein the customer devices are ground stations in simultaneous communication with multiple satellites.

10. The automated process of claim 9 wherein the satellite having the channel dedicated to the multi-cast of the shared media program of the plurality of distribution nodes is one of several distribution nodes in simultaneous communication with the customer devices placing the requests for the shared media devices, and wherein the multi-cast channel is provided on the same one of the plurality of distribution nodes but not on the other nodes of the several distribution nodes.

11. A distribution management system of a wireless networking system, the distribution management system having a processor, a non-transitory data storage and an interface to support communications with a plurality of customer devices via a plurality of distribution nodes, wherein the non-transitory data storage comprises computer-executable instructions that, when executed by the processor, perform an automated process comprising:
identifying a plurality of shared media programs that are received by more than one of the customer devices;
dedicating, for each of a plurality of shared media programs, a multi-cast channel on at least one of the distribution nodes to a multi-cast of the shared media program;
obtaining, by the distribution management system for each of the plurality of shared media programs, segments of the shared media program for re-transmission on the multi-cast channel associated with the shared media program; and
distributing, to each of the customer devices via the wireless networking system, a manifest describing the shared media programs and identifying the multi-cast channel and distribution node that is dedicated to the multi-cast of the media program to thereby permit each of the customer devices to obtain the segments of the shared media program from the multi-cast of the media program.

12. The distribution management system of claim 11 wherein each multi-cast channel is represented by a multi-cast internet protocol (IP) address provided on a wireless interface of the distribution node that is dedicated to the multi-cast of the media program, and wherein the segments of the shared media program are transmitted by the wireless interface of the distribution node using the multi-cast IP address identified in the manifest.

13. The distribution management system of claim 11 wherein the at least one of the distribution nodes is one of several distribution nodes in simultaneous communication with the customer devices placing the requests for the shared media devices, and wherein the multi-cast channel is provided on the at least one of the distribution nodes but not on the other nodes of the several distribution nodes.

14. The distribution management system of claim 11 wherein each of the plurality of distribution nodes is a satellite, and wherein the customer devices are ground stations in simultaneous communication with multiple satellites.

15. The distribution management system of claim 14 wherein the satellite having the channel dedicated to the multi-cast of the shared media program of the plurality of distribution nodes is one of several distribution nodes in simultaneous communication with the customer devices placing the requests for the shared media program, and wherein the multi-cast channel is provided on the same one of the plurality of distribution nodes but not on the other nodes of the several distribution nodes.

16. The distribution management system of claim 11 wherein each of the plurality of distribution nodes is a 5G cellular access point, and wherein the customer devices are in simultaneous communication with multiple 5G cellular access points.

17. The distribution management system of claim 11 wherein each of the plurality of distribution nodes is a wireless local area network (WLAN) access point, and wherein the customer devices are in simultaneous communication with multiple WLAN access points.

18. A wireless communications system for providing access to media streams available via network to a plurality of customer devices, the wireless communications system comprising:
a plurality of distribution nodes each configured for wireless communications with the plurality of customer devices; and
a distribution management system configured to:
identify a plurality of shared media programs that are received by more than one of the customer devices;
dedicate, for each of a plurality of shared media programs, a multi-cast channel on at least one of the distribution nodes to a multi-cast of the shared media program;
obtain, by the distribution management system for each of the plurality of shared media programs, segments of the shared media program for re-transmission on the multi-cast channel associated with the shared media program; and
distribute, to each of the customer devices via the wireless networking system, a manifest describing the shared media programs and identifying the multi-cast channel and distribution node that is dedicated to the multi-cast of the media program to thereby permit each of the customer devices to obtain the segments of the shared media program from the multi-cast of the media program.

19. The wireless communications system of claim 18 wherein each of the plurality of distribution nodes is a satellite, and wherein the customer devices are ground stations in simultaneous communication with multiple satellites.

20. The wireless communications system of claim 19 wherein the satellite having the channel dedicated to the multi-cast of the shared media program of the plurality of distribution nodes is one of several distribution nodes in simultaneous communication with the customer devices placing the requests for the shared media program, and wherein the multi-cast channel is provided on the same one of the plurality of distribution nodes but not on the other nodes of the several distribution nodes.
